(19) United States
(12) Patent Application Publication
(10) Pub. No.: US 2009/0202409 A1
(43) Pub. Date: Aug. 13, 2009

(54) Temperature controlled gas contactor device and method

(76) Inventors: David A. Smith, Lawrencevile, NJ (US); Robert M. Cowan, Dayton, NJ (US); Michael C. Tractenberg, Lawrenceville, NJ (US)

Correspondence Address: Martin L. McGregor, 26415 Oak Ridge Drive, Spring, TX, 77380, US

(21) Appl. No.: 12/321,106

(22) Filed: Jan. 14, 2009

Related U.S. Application Data
(60) Provisional application No. 61/021,011, filed on Jan. 14, 2008.

(51) Int. Cl. B01D 53/14; B01D 46/46; C01B 31/20

(52) U.S. Cl. 423/228; 95/14; 95/18; 95/16; 96/5; 423/220; 423/230

(57) ABSTRACT

This invention provides a method and process for the facile extraction of selected gases by means of a permeable membrane module, also known as a permeator, with effective and beneficial control of temperature the apparatus allowing temperature gradients or isothermal operation.

The isolation and removal of subject gases, particularly those arising from combustion, i.e., combustion gases, is usually accomplished by means of absorber and stripper towers containing various packings to facilitate gas-liquid interaction. The inlet temperature has to be controlled but the temperature varies along the length of the tower height. In contrast, a membrane-based separation device, whether it is a permeator design or a traditional two body absorber and stripper, operates better, particularly if driven by a catalyst, under a controlled temperature regimen. This is because, unlike a traditional absorber stripper where liquids may evaporate or condense with little impact on the system operation, evaporation of one phase will cool the other phase resulting in condensation that will slow the diffusion of the combustion gasses of interest.

Attempts to provide internal temperature homogeneity by use of an external heat sink have been found wanting due to insufficient transfer of heat between the internal and external sites of the permeator as well as logistic and corrosive concerns with scale-up modules.

The use of an internal construct to provide temperature control within the permeator is the subject of this invention. More specifically it is the use of internal transport constructs to precisely control the internal temperature of the permeator without the attendant loss of selectivity caused by employing a rapid flooding with temperature control liquids or gases.

### RELATED APPLICATIONS

This application claims priority from and is a continuation in part of U.S. Provisional Application 61/021011 Filed Jan. 14, 2008.

### STATEMENT REGARDING FEDERALLY SPONSORED RESEARCH

This Invention was made during the term of Department of Energy Cooperative Agreement No. DE-FC26-07NT43084 and the Government of the United States may have certain rights regarding the invention.

### FIELD OF THE INVENTION

The invention is an improved method and apparatus for gas separation.

### BACKGROUND OF THE INVENTION

The separation, isolation and capture of carbon dioxide and other gases subsequent to the process of combustion has been the subject of much literature as well as the basis for the construct of various devices. Methods for the removal of carbon dioxide from a mixed gaseous environment have taken three principal approaches. In two of these approaches a hetero-mixture of gases are contacted with a liquid which permits the facile transport of some of these gases through the liquid phase, and the selective absorption and removal of one of these gases, principally carbon dioxide occurs simultaneously or sequentially.

The earliest embodiment of these methods involves bubbling the mixed gas phase through an alkaline environment, and using either an aqueous solution of metallic hydroxides or a solution of amines in the liquid phase.

When carbon dioxide in the gaseous phase is equilibrated with a liquid solution, the dissolved carbon dioxide is then converted to the very soluble ionic form, such that the carbon dioxide is removed from the mixed gaseous composition. The major problem with such methods of extraction is a) the need for caustic alkali extraction, or b) for corrosive amines, and c) the large amount of energy and high cost needed for carbon dioxide transport and storage. A large number of other methods for capture are under development. One example is U.S. Pat. No. 6,635,103 (Sirkar et al) which discusses the use of polymeric moieties containing amine functional groups to selectively adsorb and transport carbon dioxide.

In order to improve the rate of carbon dioxide absorption and removal (desorption), the use of catalysts, e.g., the enzyme carbonic anhydrase, has been proposed. These facilitate the dissolution of carbon dioxide gas into aqueous phase by rapid solubilization. In this embodiment the gas is contacted with an aqueous environment in the presence of carbonic anhydrase and the non-carbon dioxide gases are free to dissolve into the liquid film (commonly an aqueous salt solution) while the carbon dioxide is trapped as ionic equivalents, and removed by reconversion to the gas form. A preferred method is to immobilize of the enzyme at the gas-liquid interface. A membrane module often termed a permeator is one configuration, of many, to discriminate, isolate, and remove carbon dioxide from a heterogeneous gas or liquid stream.

Gas separation is the subject and method of:

WO 2004/060539 (Membrane for Separation of Fluids); U.S. Pat. No. 3,396,510 (Liquid Membranes for the Use in Separation of Gases): U.S. Pat. No. 3,910,780 (Separation Barrier for the Preferred Transport of Carbons Dioxide and the Apparatus Employing Same); U.S. Pat. No. 3,982,897 (Filter and Detection in the Removal of Carbon Dioxide from a Gas Stream); U.S. Pat. No. 4,750,918 (Selective Permeation Gas Separation Process and Apparatus); U.S. Pat. No. 4,789,468 (Immobilized interface solute-transfer apparatus); U.S. Pat. No. 4,973,434 (Immobilized Liquid Membrane); U.S. Pat. No. 6,156,496 (Gas Separation Using a Hollow Fiber Containing Liquid Membrane); U.S. Pat. No. 6,635,103B2 (Membrane Separation of Carbon Dioxide); U.S. Pat. No. 6,756,019B1 (Microfluidic Devices and Systems Incorporating Cover Layers); U.S. Pat. No. 6,958,058B1 (High Performance Immobilized Liquid Membrane for Carbon Dioxide Separations).

The scale-up of the hollow fiber contained liquid membrane configuration has revealed that the transport of combustion gases through such a device (permeator), may result in temperature fluctuations due to condensation or evaporation of condensable fluids in the combustion gas stream, the liquid membrane or from an vapor assist in the sweep gas stream. Generally, the volatile liquid is water and the action is its attendant evaporation from the liquid membrane.

Attempts to affect homogeneity in permeator temperature by macromethods, i.e., by water jacketing or by water core via a central pipe, i.e., external means, have been shown to be ineffective. It is also noted that the relatively slow rate of thermal transfer across the permeator's external boundary makes it an ineffective method of temperature control.

In order to overcome these problems and limitations, a construct of hollow fibers was developed to transport a heat conducting liquid, intimate to the sites of gas transport, heat generation and or cooling, condensation, and associated reactions and with reference to the thermal conductivity of each of the materials—metals and fluids—present in the device. The object of this novel heat transfer fiber system is not simply to maintain the device isothermal by providing massive delivery of hot fluid, well distributed, in the apparatus (as would be needed due to the low thermal conduction of the material (polymer or ceramic)) and of the fluid (unstirred water). Rather, it is to establish an axial thermal gradient that will guarantee sufficient partial pressure difference along the entire axial length, despite changes in local absolute partial pressure, to effect uniform gas separation. This approach is both necessary and beneficial. It is needed because if one or more components in each of three key streams—the feed-retentate, contained liquid membrane, or the sweep-permeate—streams have sufficient vapor pressure to evaporate or to condense then evaporative cooling may reduce the local temperature below that needed for successful separation.

### SUMMARY OF THE INVENTION

The invention provides a device and a method to control temperature in a gas contactor by the use of either external or internal temperature control. The device is one or more gas contactors preferably comprising hollow fibers of the type described in published U.S. patent application 2007/0004023. A preferred device and method may be adapted to maintain isothermal conditions by means of internal temperature control, preferably by means of the use of a heat transfer fluid. In an especially preferred device one is able to control thermal conditions by the deployment of heat transfer liquid flow through the device in a direction countercurrent to the feed gas flow. In a preferred method an axial gradient is maintained in the contactor with the high temperature at the sweep gas end of the device. The invention also provides a gas contactor device that comprises internally conductive membranes and heat transfer liquids to affect thermal conditions within the device. A preferred device has a heat transfer liquid that is water or a solution largely of water or miscible with water such that the heat transfer liquid is a water soluble liquid or the liquid is water miscible.

The third embodiment includes the use of a condensable fluid sweep (such as water or a water immiscible fluid such as a halogenated hydrocarbon) which serves to assist in obtaining high purity permeate by maintaining a temperature gradient within the device.

During operation of the device the partial pressure of the gases moving across the polymer and liquid membranes may decrease to a level such that gas separation may fail at the permeate end of the permeator. Thus, the necessity of heat (from the heat transfer fluid) to maintain proper temperature so that an appropriate partial pressure differential is maintained for the fluid of interest to guarantee gas mass transfer in the preferred direction. A device that comprises heat transfer fibers (or heated wires or filaments) within a membrane permeator, or other membrane apparatus or hollow tube ceramic apparatus, may be employed to control temperature, within narrow limits, by having a sufficient flow of thermally regulated fluid pass through the fibers, not only to compensate for losses or gains that would occur by virtue of the uncontrolled operation of the device, but to directly control the thermal gradients to effect selective gas flows. An additional object of this invention is the enablement of a device, a permeator, contactor or reactor, that contains a multitude of hollow fibers to deliver or remove one or more fluids from a common or shared fluid. The use of a variety of membrane-type structures to separate one fluid from the next, the use of microporous or thin skinned membranes to control fluid movement and/or selectivity, the presence of a liquid reactive layer to selectively extract one component from a mixture to effect a reaction that in turn yields a product of specified character. It is a further intent to describe an internal heat transfer array, generally a set of non-porous heat transfer hollow fiber tubes, to maintain a specific thermal profile in the device to maximize separation by aiding in the creation of a partial pressure gradient. It is a yet further intent to describe a mode of sealing heat transfer hollow fibers or of preventing them from becoming porous so as to generate porous and non-porous zones to allow construction of a device with areas where source and product gases can be added and removed. The reactive fluid may be a liquid, a gel or a gas.

### DESCRIPTION OF THE DRAWINGS

FIG. 1a is a side view of a device of the invention.

FIG. 1b is a cross sectional end view of the device of FIG. 1a.

### DETAILED DESCRIPTION OF THE INVENTION

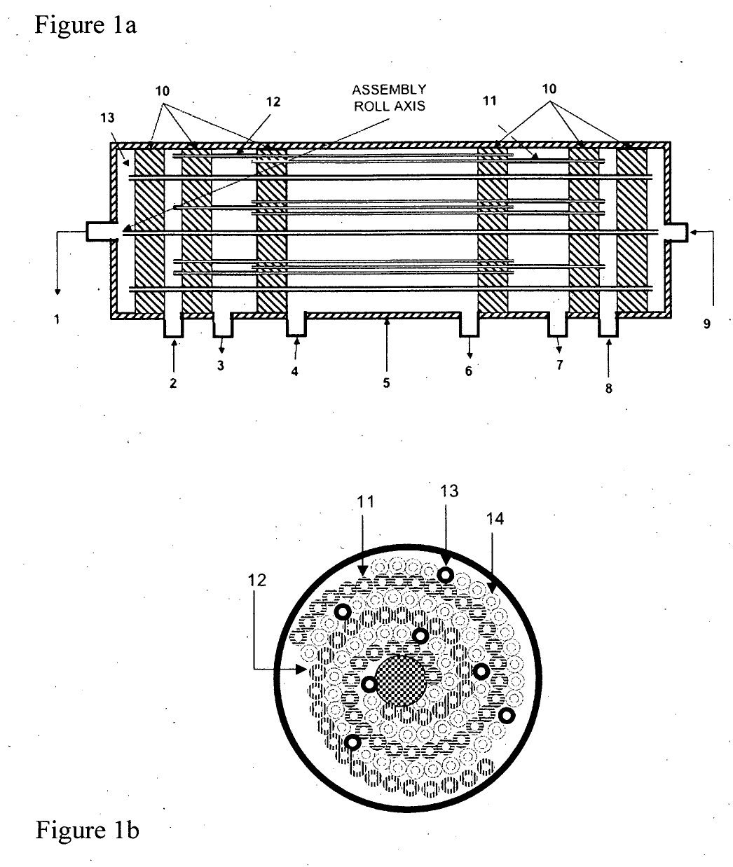

The numbered elements in FIG. 1 represent the following materials or functions for this Permeatordevice as one embodiment of many.
1. Heat transfer fluid.
2. Feed gas-containing components that will move into the liquid on the other side of the semi permeable or microporous membrane by chemical facilitation.
3. Permeate gas that has been enriched from the feed gas by chemical facilitation. This stream is usually maintained under a vacuum.
4. Contained liquid membrane supply.
5. Shell of the Permeator device.
6. Contained liquid membrane discharge to regenerator.
7. Retentate. The feed gas that has been depleted of the chemically facilitated transport gas.
8. Sweep gas;
9. Heat transfer fluid supply after reheating of fluid from 1.
10. Tubesheets. These separating elements (commonly glue lines) to keep each stream separate. They are expected to be made of a glue type material (e.g., epoxy, thermoplastic) as may be determined to facilitate construction and system life.
11. Permeate membrane hollow fibers. The end portion that is exposed to the Retentate gas needs to be impervious (have very low permeability) to both sweep and retentate (supply and permeate) gases. This may be accomplished by the use of a coating or supplying impervious tubing on just this retentate exposed area.
12. Feed Fibers exposed to the Permeate Gas. As in 11 they must be impervious to the feed and permeate gas.
13. Heat Transfer Fluid. Transfer fluid tubing that will carry the Heat Transfer Fluid heat transfer fluid or other heating systems. This material is to be constructed of materials that are impermeable to all the materials within the Permeator device. This includes the Heat Transfer Fluid, Feed Gas, Liquid Membrane, Retentate, and Permeate Gases.
14. Spacer material. This is commonly a cloth or fabric that acts to hold the feed/retentate hollow fibers a prescribed minimum distance from the sweep/permeate fibers. Its presence is optional.

The use of this invention will allow for the development of a device that is able to perform its function in a way that will maximize the usefulness of the equipment, minimize the operating variation, allow for a significant increase in the size that a device can be constructed to thus lowering the constructed cost of a completed site. Thermal control also protects the device from damaging thermal expansion and contraction.

One objective of this invention is to describe a method for the effective temperature controlled (isothermal or axial temperature gradient) operation of a membrane-based separations device, i.e., a permeator or a contactor. The preferred configuration eliminates the structural limitation of scaling and the operational limitation of undesirable heat transfer via condensation or evaporative cooling, as described below. The heat transfer elements can absorb or deliver thermal energy as needed to promote the temperature control within the liquid membrane portions of the device.

One use of the invention is to support the construction of ever larger contactors or permeators because they can be considered multiples of a simple small design. Larger devices enjoy a scale factor as the plumbing and controls remain the same independent of size while the casing increases linearly while the volume increase by the square.

Another use is to maintain operational stability independent of the inlet temperature, direction or flow rate of the liquid membrane, and relative humidity, and, independent of the vapor pressure of the liquid in the device.

A benefit is that the use of internal thermal controls makes the operation of the permeator device independent of the other flows into and out of the permeator device. By this it is meant that the liquid membrane flow rate does not have to change based on thermal load. The thermal load will go up as the operating temperature of the permeator increases.

Uncontrolled temperature, as a result of evaporative cooling, can result in condensation in bore or pores of hollow fibers. Controlled heating as a result of intimate contact between the heat transfer fluid fibers well distributed throughout the cross section of the device, preferably a permeator, can result in uniform heating and proper heat transfer fluid flow rate can produce a controlled temperature gradient longitudinally throughout the device. This will allow for a high total pressure from a condensable gas at the sweep end, where the facilitated gas is in short supply and the only driving force for flow will be the vapor pressure of the condensable gas. With the lower temperature at the permeate end, the total pressure is kept low despite the abundant facilitated gas partial pressure because of the low partial pressure of the condensable gas at this lower pressure.

The prior art used an external heat source such as a jacked piece of equipment or submerged the equipment into a water bath to keep the liquid membrane at temperature and to heat the liquid membrane as it enters the permeator. Submerging the equipment in a water bath leads to a variety of problems including but not limited to corrosion, limitations of size, messiness of handling the supplies, and the discharge streams in a water bath need to be routed up and out of the tank thus collecting water slugs. Furthermore, if any condensation takes place it will fill the discharge line with condensate, affecting the pressure losses and other parts of the system. If one uses one of these heat delivery approaches that do not supply heat in a well distributed manner it is not possible to scale up the device to any reasonable size. This is because there can only be a relatively limited distance within the permeator from the heated wall to the location where evaporation is taking place. The evaporation requires the addition of heat in order to avoid a decrease in the temperature. If the distance required for heat transport is too great the operating temperature in the remote location from the heat source will decrease below the desired value. This can cause condensation in the feed/retentate fiber bore and make it impossible to maintain the desired water vapor pressure in the sweep/permeate fiber. Both are undesirable as they will severely limit device performance. In theory, this tendency could be overcome by heating the contained liquid membrane and pumping it through the permeator quickly to balance the heat loss from evaporation. However, the increase in liquid membrane turnover within the device results in a deleterious reduction of selectivity between undesired vs. desired gasses in the operation of the permeator. Since the purpose of the permeator is to maintain a high selectivity as well as capacity, the velocity of the contained liquid membrane must be controlled.

### Terminology:

As used in this application, gas capture and gas sweetening refer to the selective extraction of specific gases from a mixture, generally acid gases where one of the more commonly extracted gases is carbon dioxide.

The term permeator is used to designate a device in which absorption and desorption occur simultaneously albeit at opposite surfaces across a liquid film. If the liquid film is contained between two surfaces the device is known as a contained liquid membrane.

Alternatively, the liquid film may be an immobilized liquid membrane where the liquid is placed within the pores of a porous membrane the aggregate of the pores providing a feed surface at the ends of the pores on one side of the membrane and the membranes is placed in contact with the sweep gas to provide a permeate end, the aggregate of such pore ends forming a permeate surface on the other side of the membrane. To function as an immobilized liquid membrane the pore size and pore wall surface must be selected to produce conditions that retain the liquid within the pore. In either the case the partial pressure of the gas of interest has to be higher on the feed side than it is on the permeate side for the separation to proceed. When the liquid that makes up the liquid membrane or the liquid that is in the feed stream or the sweep stream is volatile then, depending on the temperature gradients condensation heating or evaporative cooling may occur. Under such circumstances then the separation device may perform less well than expected or may even fail. In the face of these temperature dependent processes and failure modes it is necessary to effect thermal management to maintain effective and controlled performance.

The isolation and removal of subject gases from combustion is usually accompanied by higher than desired temperature levels. Cooling within the permeator by the process of evaporation can result in uncontrolled condensation of the attendant water from the combustion process as well. Structural deformity with the permeator due to temperature variations can provide an additional challenge to such a device. The deployment of catalysts such as enzymes can also be adversely effected by variations of temperature, and too high temperatures may deactivate the catalyst.

When a gas stream enters an aqueous liquid membrane based permeator, it may or may not be saturated with water vapor, but it will quickly become saturated due to evaporation of water from the liquid membrane. If the liquid membrane is cooled by the evaporation, condensation within the pores of the membrane may occur and may reduce gas transfer. To prevent or control evaporation, thermal management is required. Under ideal conditions, the permeate gas will be saturated with water vapor as it leaves the permeator, taking heat with it and leaving the liquid membrane colder in the absence of heating. Heat can be added to the liquid membrane by external heating or internally by an added heating means. A preferred method is to employ a heat transfer fluid that is circulated at sufficient velocity to compensate for the heat loss. This heat transfer fluid is delivered through use of a network of impermeable hollow fibers distributed within the permeator. The use of the heat transfer fiber network is the preferred approach since it avoids high flow rates of the liquid membrane and controls the direction of flow for the liquid membrane, that may reduce the selectivity of the membrane. It avoids the use of the liquid membrane as the heat transfer medium thus allowing control of liquid membrane flow to be done for the sole purpose of maximizing separation performance (i.e., avoiding use of high flow rates of the liquid membrane, or mixing the fluids, as these will lead to reduced selectivity of the separation, which is Undesirable, or even to reverse flow into the retentate. In one example the liquid membrane flow is arbitrarily selected to allow for water to evaporate and produce a concentration profile of no greater than a 10% increase of non-volatile components from its supply source before it is discharged for regeneration. The lowest flow rate possible or highest concentration acceptable is preferred. Since the liquid membrane is not the preferred heating media, a secondary heating medium is described below.

Another point of importance is the equilibrium condition of the liquid membrane at any point within the permeator. As the liquid membrane moves through the permeator, it will transfer a selected gas, such as CO₂ in our examples, across different partial pressure profiles and will therefore contain higher amounts of CO₂ at the feed entrance/permeate exit end than at the sweep entrance/retentate exit end, when the gases flow in the preferred countercurrent contact method. In a preferred condition the highest concentration of CO₂ containing liquid membrane should enter at the sweep/retentate end where it will have a greater impact on the extraction capability, than if the lower CO₂ concentration liquid membrane from the sweep/retentate end were introduced at the feed/permeate end. This condition means the rehydrated liquid membrane needs to be pumped into the feed/retentate end.

Certain conditions are required for the gas flow in the sweep to permeate direction to maintain a positive flow and a positive partial pressure for removal (capture) of CO₂ or other selected reactive gases. One condition is that the permeate will be saturated with liquid membrane vapor (water hereafter in this discussion) while another is that it needs to contain the highest possible partial pressure of the selected gas. Since the partial pressure of water vapor is set by the temperature of the permeate, and that will be determined by the temperature of the feed. Were the temperature of the sweep not to change the absolute pressure of the sweep would be lower than that of the permeate. This situation is not desirable if the length of the permeator is to be used for mass transfer. This implies that the temperature of the sweep must be higher than that of the permeate. Further, that the temperature increase must result in an increase of the partial pressure of water vapor from the permeate by an amount greater than the partial pressure of the CO₂ in the permeate. This further implies that a portion of the water vapor of the sweep will pass into the liquid membrane. The rate of condensation into the liquid membrane must be low enough that it will not block the pores and thus reduce the flow of CO₂. At the higher temperature at the sweep/retentate end the retentate will evaporate water from the liquid membrane, resulting in a loss of heat from the liquid membrane. The requisite amount of heat will be made up from the heat transfer fluid.

### Liquid Membrane Characteristics

Trachtenberg U.S. Published Patent application 2007/0004023 describes a liquid film held in place between two sets of hollow fibers. He termed the liquid film a contained liquid membrane. By virtue of the geometry, formed either by laying up flat sheet or hollow fiber arrays or by means of extrusions, etc. the liquid film exhibits a rectilinear geometry whose length and height are far greater than its thickness, and thus forms a membrane. The term liquid should be taken to mean any non-solid, i.e., a gel, liquid, or condensed gas.

### Heat Transfer Fibers & Thermal Gradients

Attempts to provide internal temperature control to achieve isothermal conditions by use of external heat sources often are found wanting due to the ineffective transfer of heat between the internal and external sites of the apparatus. This is due to the thermal resistance of the component materials—polymers, ceramics, water, etc. resulting in a very low rate of thermal conduction. In an apparatus such as a hollow fiber permeator that has about two-thirds of its volume occupied with polymer material, for example, which has very poor thermal conductivity, and the final third with a poorly stirred liquid the ability to distribute heat uniformly will be severely compromised. As the module becomes progressively larger uniform heat distribution will be impossible to achieve when it is provided from a shell or a shell and core delivery system. The use of an internal construct to provide an isothermal permeator is one object of this invention. More specifically it is the use of internal transport constructs to precisely control the internal temperature of the permeator without the attendant loss of chemical product selectivity, as would be caused by employing a rapid flooding with temperature control liquids or gases, i.e., a thermal gradient is preferred.

### Condensable Sweep

The use of water vapor as a condensable sweep is well known. However, other compounds that could be used beneficially are less well understood. These include but are not limited to chlorinated hydrocarbons such as TCE (CAS#: 79-01-6) or PERC (CAS#: 127-18-4), refrigerants such as tetrafluoroethane (R-134a, CAS#: 811-97-2), or other substances with low water solubility and that can be provided as a sweep gas but easily separated from the product gas (i.e., CO₂) by condensation. Preference is given to compounds having low flammability, low toxicity, and minimal environmental impact (e.g., R-12 may be useful but R-134a is preferred because R-12 is a CFC that can cause damage to the ozone layer).

### Embodiments

### Overall Design

The invention may be considered as an apparatus for preferred extraction of a gas from a mixture of gases present in a first phase via a second phase wherein a selective process occurs to react with the gas of interest enhancing either or both the rate of removal or the maximal allowable concentration of said gas such that the enriched gas or gas equivalents in the second phase extract selectively into third phase wherein they may leave the system or be provided to another such stage. It may also be:
i. An apparatus constructed of microporous membranes.
ii. An apparatus constructed of multiple layers of microporous membranes.
iii. An apparatus where respective layers are may be separated by spacers, wherein such spacers contain a spacer material.
iv. Wherein alternate spaces are filled with gas, either a feed gas or a permeate gas and with liquid to a formation of feed gas-membrane-liquid-membrane-permeate gas, repeat.
   1. An apparatus wherein one spacer includes heat transfer elements.
      1 Wherein the heat transfer elements are conductors.
      2 Wherein the heat transfer elements are resistance heaters
      3 Wherein the heat transfer elements are inductive heaters.
      4 Wherein the heat transfer elements are carriers of a hot liquid, i.e., tubes, even microtubes suc as hollow fibers.
      5 Wherein the heat transfer elements are woven into the spacer material.
v. An apparatus wherein the microporous membranes serve to maintain a phase separation operating as microfluidic boundary separators.
   1. A microporous membrane made of a polymer
      1 A membrane where the polymer is polypropylene.
   2. A microporous membrane made of a metal.
   3. A microporous membrane made of a ceramic.
      1 A membrane where the polymer is polypropylene.
2. An apparatus wherein the microporous membranes are flat sheets or woven hollow fibers to form a loose sheet-like array or are non-woven fibers provided that the open ends of the fibers are accessible.
3. A process wherein gas separation is accomplished by means of a selective extraction of one species from a mixed gas first phase by means of a reaction via a compound in a second liquid phase that increases either or both the rate of entry of the gas into the liquid or increases the capacity of the liquid for the gas or gas equivalents by thermal control of separation conditions.
4. A process in which the gas or gas equivalents in the liquid exit the liquid phase into a third phase, here a gas phase, now in an enriched concentration as a fraction of the total.
5. A process wherein the liquid phase enrichment is accomplished by means of a reactant in the bulk fluid or at the gas-liquid interface.
6. A process where the preferred gas is carbon dioxide.
7. A process wherein the reactant is an amine.
8. A process where the catalyst is the enzyme carbonic anhydrase.
9. A process where the catalyst is the enzyme carbonic anhydrase and the amine is a secondary or tertiary amine.
10. A process where the catalyst is the enzyme carbonic anhydrase and the bicarbonate carrier is a metal or a metal salt.
11. A process where the metal is preferably a member of group IA alkaline metals.
12. A process where the catalyst is the enzyme carbonic anhydrase and the bicarbonate carrier is ammonia or an ammonium salt.

### EXAMPLES

1. A permeator designed as in figure as in I FIG. 1 was constructed and flue gases at 55 degrees Celsius with a flow rate of 280 cc/min. at with a dew point of 47 degrees Celsius was passed though the construct from (2) to (4) but without the transport of any (CLM) (4) (6) liquid membrane or heat transfer fluid. After 5 hours of operation, the permeate (3) which initially had a temperature of 50 degrees Celsius, was found to have a temperature of 49 degrees Celsius. Water was observed “spitting” out of the retentate nozzle (4) and the carbon dioxide (CO₂) permeate (3) flow was reduced 50%. After 5 hours the temperature of the liquid membrane continued to drop with more water appearing in the retentate. After a few days without water make-up the water pressure in the permeator was severely reduced, the quality of separation was adversely affected and a 95% removal of CO₂ from the feed stream was reduced to 15% on a dry basis.

2. The conditions of Example 1 were repeated, but with an external heat reservoir applied to the liquid membrane to maintain the temperature at 50 degrees Celsius (6) (4). The heat required to maintain the permeator at constant temperature was greater than 50 J/min. transfer into the liquid membrane at 12 g/min suffering a 1 degree Celsius temperature loss. The permeate gas flow rate was very high, but the quality of the permeate was very low, yielding under a 60% CO₂ level on a dry gas basis, from an initial 95%. The concentration of water within the liquid membrane was maintained by adding water to replace that which was lost during operations. No heat was added to nozzle (9).

3. Example 1 was repeated with the transport of the liquid membrane in the same direction of flow as the permeate (6) to (4) with a heat source on the liquid membrane, but with a flow rate reduced to 0.2 g/min. The quality of the permeate was initially greater than 95% CO2, but the amount of heat needed to maintain the temperature was too great and the carbonic anhydrase (CA) was found to denature. After 5 hours the temperature of the permeate was found to be 49 degrees Celsius and falling. The carbon dioxide was found to be less than 60% from the original 95% within the permeate. With continued operation, the quality of the permeate continued to suffer and the experiment was halted after 2 days.

4. Example 3 was repeated but a heat transfer fluid was employed in addition to the liquid membrane. The heat transfer fluid flowed from nozzle (9) to nozzle (1) at a rate of 12.0 g/min. of water and the liquid membrane flowed at a rate of 0.2 g/m from (6) to (4). The heat transfer fluid supplied 50 J/min with a 1 degree Celsius loss. The liquid membrane was unheated, entering 10 degrees Celsius below the liquid membrane exit temperature. The liquid membrane exit temperature maintained 50 degrees Celsius. The retentate stream (4) CO₂ concentration was reduced from the feed stream (2) by 70% to 4.5%. The permeate concentration was good with the CO₂ maintained above 90% and with a good flow rate. Since the water level was maintained by replacement of the evaporated water, the pressure was also maintained and the system operated successfully for several days until the experiment was terminated.

5. Example 4 was repeated but with the flow of the liquid membrane structured to be opposite to that of the permeate. In at (4) and out at (6), the lost water was reconstituted before the liquid membrane was returned to the nozzle at (4). After 5 hours, the rate of carbon dioxide removal was maintained at 90% with an outlet CO2 concentration of 1.6%. The permeate concentration was 95% on a dry basis. This level of performance was maintained for two weeks, after which the experiment was terminated.

6. Example 4 was repeated but with the following conditions: Feed at 184 accm, Sweep at 83 accm, Permeate at 1224 accm, Retentate at 195 accm. Flow of the liquid membrane structured to be opposite to that of the permeate at 1.2 ccm. In at (4) and out at (6), the lost water was reconstituted before the liquid was returned to the nozzle at (4). Heat transfer fluid rate, in at (9) out at (1) flowing at 10.7 ccm After 5 hours, the rate of carbon dioxide removal was maintained at 85% with an outlet CO₂ concentration of 2.09%. The permeate concentration was 80% on a dry basis. In this case, the experimental data had the heat transfer fluid inlet temperature of 37.75 degrees Celsius and heat transfer fluid outlet temperature of 27.69 degrees Celsius.

We Claim:

1. A method to control temperature in a gas contactor by the use of either external or internal temperature control in order to maintain the internal temperature of the permeator above the dew point within the device.

2. A method according to claim 1 to maintain isothermal conditions by means of internal temperature control.

3. A method according to claim one that further comprises the use of a heat transfer fluid.

4. A method according claim 3 to control thermal conditions by the deployment of heat transfer liquid flow through the liquid membrane in a countercurrent flow path to the permeate.

5. A gas contactor device that comprises internally heat conductive membranes and heat transfer liquids to affect thermal conditions within the device.

6. A device according to claim 5 wherein the heat transfer liquid is water or a solution largely of water.

7. A device according to claim 5 wherein the heat transfer liquid is a water immiscible liquid.

8. A device according to claim 5 wherein the liquid is water soluble.

9. In an apparatus for selection of a gas from a mixture of gases present in a first phase via a second phase wherein a selective process occurs to react with the gas of interest enhancing a variable chosen from the group consisting of increasing the rate of removal of the gas or the increasing maximal allowable concentration of said gas in the mixed gas stream such that the enriched gas or gas equivalents in the second phase extract selectively into third phase wherein they may leave the system or be provided to another such stage, the improvement that comprises heat transfer means to control the internal temperature of the apparatus.

10. An apparatus according to claim 9 constructed of membrane materials selected from the group consisting of microporous membranes, nonporous membranes, skinned membranes, semi-permeable membranes, and perm-selective membranes.

11. An apparatus according to claim 9 constructed of multiple layers of microporous membranes.

12. An apparatus according to claim 9 where multiple layers are separated by spacers to create spaces.

13. An apparatus according to claim 12 wherein alternate spaces are filled with gas, either a feed gas or a permeate gas and with liquid.

14. A process wherein gas separation is accomplished by means of a selective extraction of one species from a mixed gas first phase by means of a reaction via a compound in a second liquid phase that increase either or both the rate of entry of the gas into the liquid or increases the capacity of the liquid for the gas or gas equivalents by thermal control of separation conditions.

15. A process according to claim 14 wherein the liquid phase enrichment is accomplished by means of a reactant in the bulk fluid or at the gas-liquid interface.

16. A process according to claim 14 where the preferred gas is carbon dioxide.

17. A process according to claim 14 wherein the reactant is an amine.

18. A process according to claim 14 where the catalyst is carbonic anhydrase.

19. A process according to claim 14 where the catalyst is the carbonic anhydrase and the reactant is a secondary or tertiary amine.
